(19) United States
(12) Patent Application Publication
(10) Pub. No.: US 2012/0173076 A1
(43) Pub. Date: Jul. 5, 2012

(54) SYSTEM AND METHOD FOR DIAGNOSING A TURBOCHARGER

(76) Inventor: Larry Gene ANDERSON, Lawrence Park, PA (US)

(21) Appl. No.: 13/234,819

(22) Filed: Sep. 16, 2011

Related U.S. Application Data
(60) Provisional application No. 61/429,605, filed on Jan. 4, 2011.

(51) Int. Cl. G01M 15/04

(52) U.S. Cl. 701/34.4; 73/114.31

(57) ABSTRACT

Methods and systems are provided for diagnosing a fault of a turbocharger of a vehicle system. The turbocharger system comprises a rotary component and a wiring harness including a plurality of signals. In one embodiment, a diagnosis kit comprises a tester, a manipulation tool, and a plurality of human readable instructions. The tester includes a connector operable to connect to the wiring harness and a plurality of connectors. The tester is configured to receive signals from the wiring harness for use in diagnosing the fault source. The manipulation tool couples to and decouples from the rotary component and the tool is operable to rotate the rotary component when the tool is coupled to the rotary component. The plurality of human readable instructions includes information on how to diagnose the fault of the turbocharger system using the tester and the physical manipulation tool.

### CROSS REFERENCE TO RELATED APPLICATIONS

This application claims priority to U.S. App. Ser. No, 61/429,605, filed Jan. 4, 2011, the entirety of which is hereby incorporated by reference.

### FIELD

Embodiments of the subject matter disclosed herein relate to a diagnostic kit, system, and a method for diagnosing a turbocharger system.

### BACKGROUND

An off-highway vehicle, such as a locomotive, a mining truck, or a marine vehicle, may include an engine having a turbocharger system. The turbocharger system may fail at some time during the operational lifetime of the vehicle, but the cause of the fault may not be readily apparent. The vehicle may include onboard electronic diagnostics to determine fault causation. However, some faults cannot be identified by the electronic diagnostics and other corrective actions must be taken to identify the root cause. Current solutions include complete removal and replacement of the faulty turbocharger system, or removal and disassembly of the turbocharger system. After disassembly, the various components can be checked individually to determine the source of the fault.

The inventors herein have recognized that replacement of an entire turbocharger system where only a portion of the turbocharger system is faulty may not be economically desirable. Removal and replacement, as well as disassembly, are labor intensive activities with associated economic disincentives. Further, service induced delay can reduce the return on investment where an entire system, such as a locomotive or mining equipment, is out of commission during the extended procedure. Thus, it may be desirable to have an apparatus and method that potentially identifies turbocharger system faults prior to removal and replacement of the entire turbocharger system.

### BRIEF DESCRIPTION OF THE INVENTION

In one embodiment, a kit for a diagnosing apparatus for a turbocharger system is provided. The kit comprises a tester including at least one connector operable to connect to a wiring harness of the turbocharger system, the tester configured to receive signals from the wiring harness for use in diagnosing the fault source, and human readable media with instructions that specify how to diagnose the fault source of the turbocharger system with the tester and without removing the turbocharger system.

In one embodiment, a method for diagnosing a fault source of a turbocharger system of a vehicle is provided. A first set of parts is electronically diagnosed to determine if any part of the first set of parts is the fault source. A second set of parts is visually inspected to determine if any part of the second set of parts is the fault source. After electronically diagnosing the first set of parts and visually inspecting the second set of parts and if no part of the first set of parts and the second set of parts are the fault source, a third set of parts is diagnosed to determine if any part of the third set of parts is the fault source. The third set of parts is diagnosed by physically manipulating a component of the turbocharger system while monitoring an output from the turbocharger system. After diagnosing the third set of parts and if no part of the third set of parts is the fault source, at least a portion of the turbocharger system is removed from the vehicle.

Thus, in one embodiment, all or substantially all of the electronically diagnosable and visually inspectable parts of the turbocharger system may be diagnosed prior to removal or replacement of any parts of the turbocharger system from the vehicle. For example, a fault may be diagnosed by visually identifying a faulty electrical connector of the turbocharger system prior to removal of the turbocharger system from the vehicle. In this manner, the turbocharger fault may be discovered prior to performing potentially labor intensive removal or expensive replacement of the turbocharger system.

This brief description is provided to introduce a selection of concepts in a simplified form that are further described herein. This brief description is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure. Also, the inventor herein has recognized any identified issues and corresponding solutions.

### BRIEF DESCRIPTION OF THE DRAWINGS

The present invention will be better understood from reading the following description of non-limiting embodiments, with reference to the attached drawings, wherein below:

FIG. 1 shows an exemplary embodiment of a vehicle including an engine, a turbocharger system, and a controller.

FIG. 2 shows an exemplary embodiment of a turbocharger system connected to a controller through one or more wiring harnesses.

FIG. 3 shows an exemplary embodiment of a diagnostic kit for diagnosing the turbocharger system, the diagnostic kit including a tester, a physical manipulation tool, and human readable media with diagnostic instructions.

FIG. 4 shows an exemplary embodiment of the tester of the diagnostic kit.

FIG. 5 shows an exemplary embodiment of the tester of the diagnostic kit.

FIG. 6 shows a flow chart of an exemplary embodiment of a method for diagnosing a turbocharger system.

FIG. 7 shows a flow chart of an exemplary embodiment of a method for diagnosing a turbocharger system.

### DETAILED DESCRIPTION

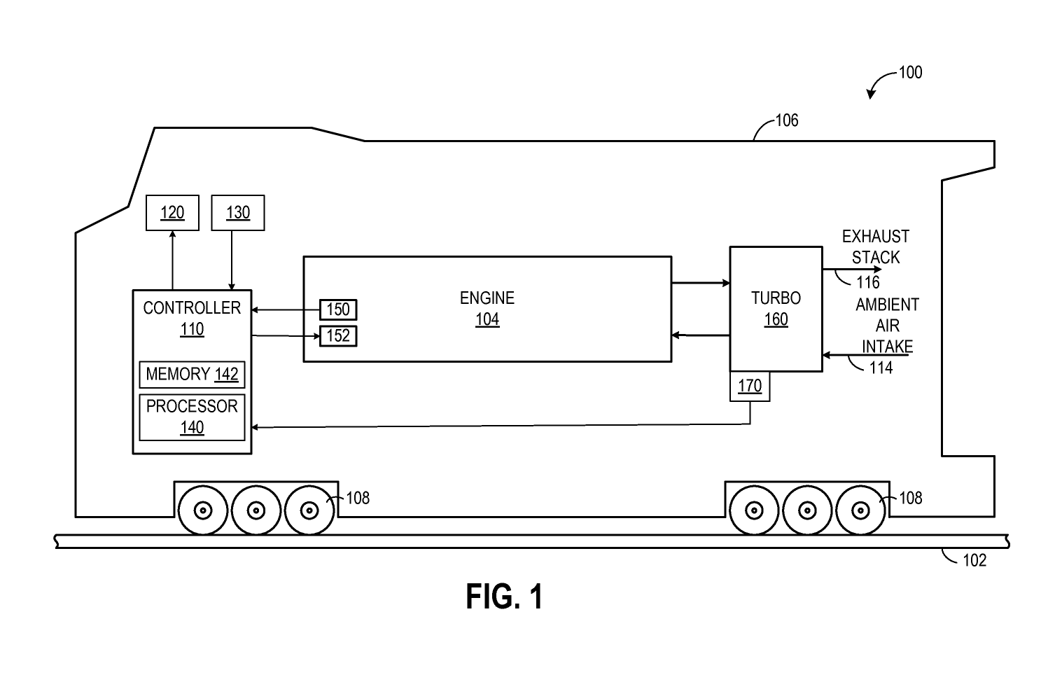

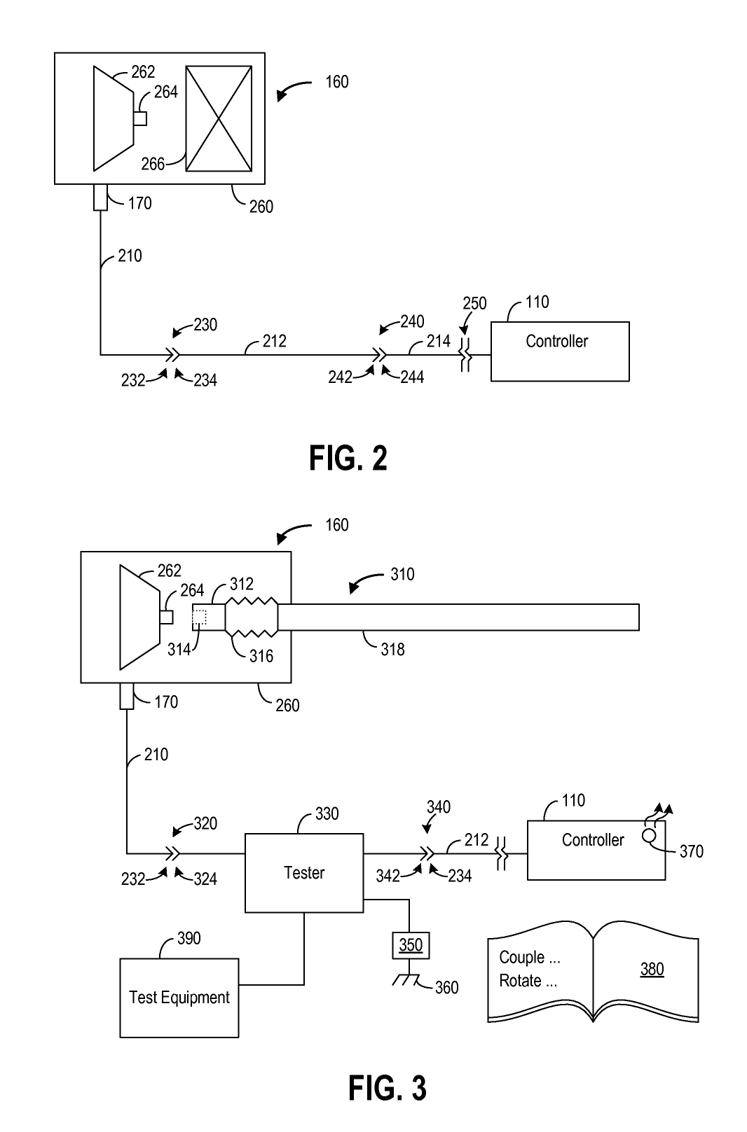

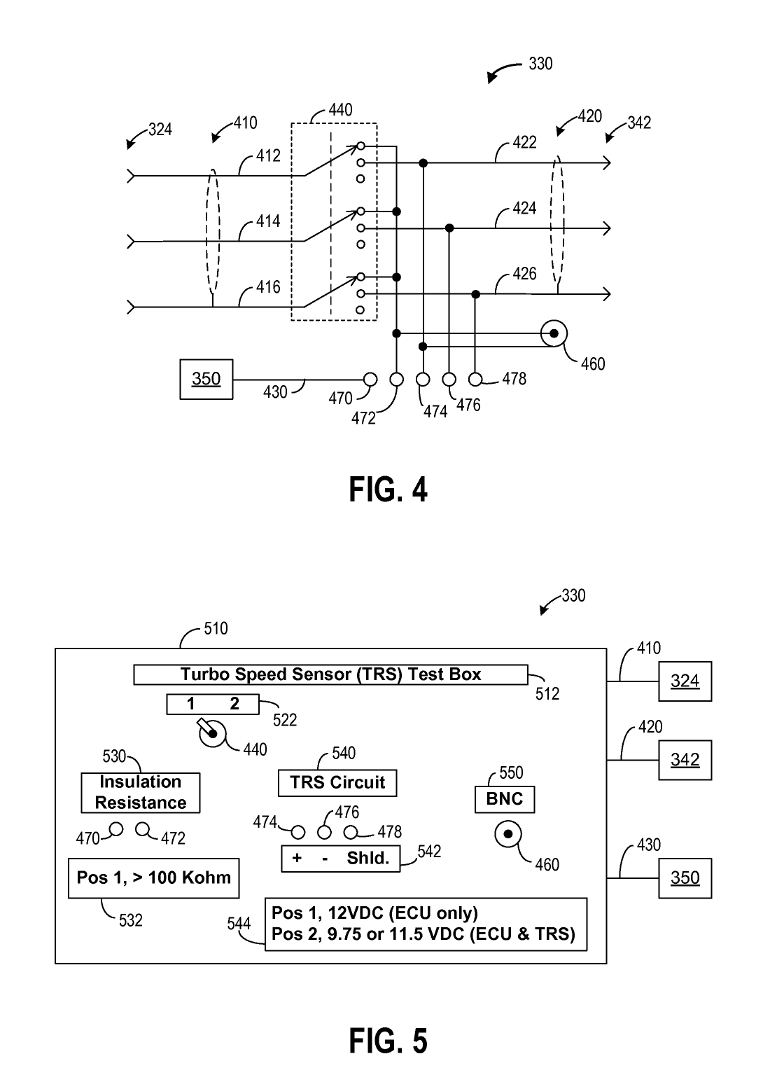

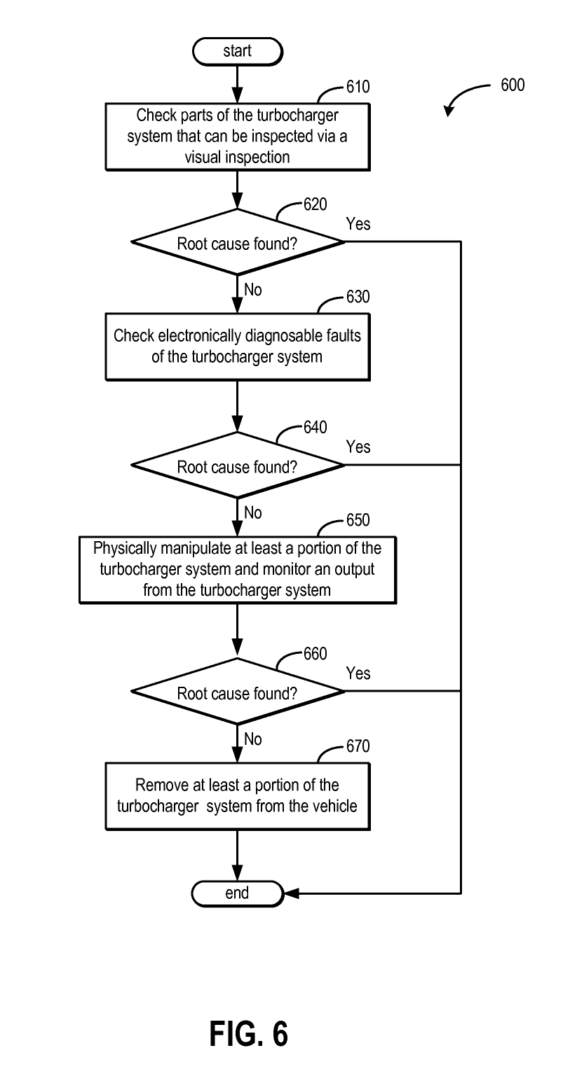

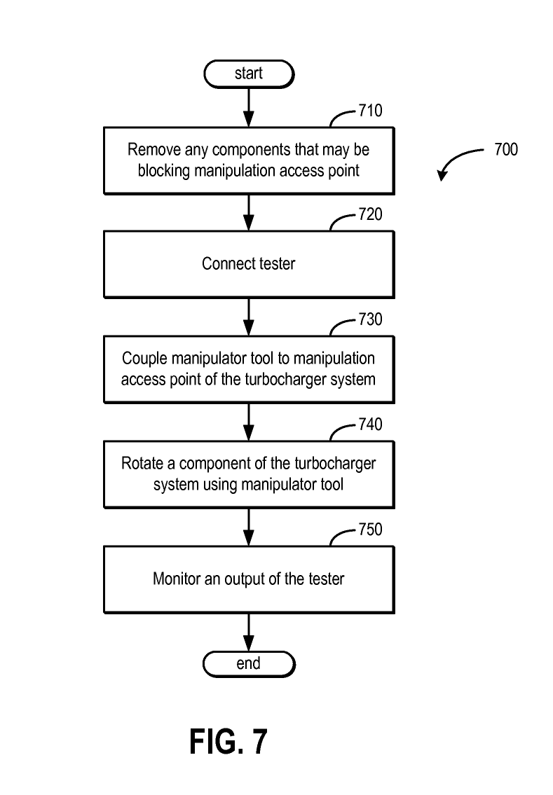

Some vehicles (such as marine vessels, mining trucks, or the exemplary embodiment of a locomotive as shown in FIG. 1) may include an engine having a turbocharger to increase power output and/or engine-operating efficiency by increasing charge density of air during combustion. The vehicle may further include a controller connected to the turbocharger system through one or more wiring harnesses, such as illustrated in the exemplary embodiment of FIG. 2. The controller may monitor and adjust the turbocharger system. For example, one or more components of the turbocharger system may fail at some time during the operation of the vehicle, and onboard electronic diagnostics of the controller may record the fault. For some turbocharger system failures, the onboard electronic diagnostics may record the root cause of the fault, but for other failures, the root cause may not be identified by the onboard electronic diagnostics. When the root cause cannot be determined by the onboard electronic diagnostics, it may be desirable to use a diagnostic kit that can potentially aid a maintenance crew in determining the root cause without removing the turbocharger system from the vehicle. FIG. 3 illustrates an exemplary embodiment of a diagnostic kit for diagnosing a turbocharger system, the diagnostic kit including a tester and human readable media with diagnostic instructions. The tester may be connected to an electronic harness from the turbocharger system to monitor an output of the turbocharger when a physical manipulation tool is used to manipulate a component of the turbocharger. FIGS. 4 and 5 each illustrate an exemplary embodiment of the tester. The human readable media specify how to diagnose the fault source of the turbocharger system using the tester and the physical manipulation tool, including instructions for connecting the tester and analyzing its output. For example, the human readable media may include instructions for implementing a method, such as illustrated in FIGS. 6 and 7, for diagnosing the turbocharger system. Thus, by using the diagnostic kit, it may be possible to diagnose the turbocharger system without performing the labor intensive step of removing the turbocharger system from the vehicle.

In one embodiment, the turbocharger may be coupled to an engine, such as an engine in a vehicle, A locomotive system is used to exemplify one of the types of vehicles having engines to which a turbocharger, or multi-turbocharger, may be attached. Other types of vehicles may include on-highway vehicles, off-highway vehicles, mining equipment, and marine vessels. Other embodiments of the invention may be used for turbochargers that are coupled to stationary engines. The engine may be a diesel engine, or may combust another fuel or combination of fuels. Such alternative fuels may include gasoline, kerosene, biodiesel, natural gas, and ethanol. Suitable engines may use compression ignition and/or spark ignition.

FIG. 1 shows a block diagram of an exemplary embodiment of a vehicle system 100, herein depicted as a rail vehicle 106 (e.g., locomotive), configured to run on a rail 102 via a plurality of wheels 108. As depicted, the rail vehicle 106 includes an engine system with an engine 104.

The engine 104 receives intake air for combustion from an intake passage 114. The intake passage 114 receives ambient air from outside of the rail vehicle 106. Exhaust gas resulting from combustion in the engine 104 is supplied to an exhaust passage 116. Exhaust gas flows through the exhaust passage 116, and out of an exhaust stack of the rail vehicle 106.

The engine system includes a turbocharger system 160 (TURBO) that is arranged between the intake passage 114 and the exhaust passage 116. The turbocharger system 160 increases air charge of ambient air drawn into the intake passage 114 in order to provide greater charge density during combustion to increase power output and/or engine-operating efficiency. In one embodiment, the turbocharger system 160 includes a compressor (not shown in FIG. 1) which is at least partially driven by a turbine (not shown). The turbocharger system 160 may include multiple turbine and/or compressor stages. The turbocharger system 160 may include a housing (not shown in FIG. 1) containing an air filter (not shown in FIG. 1) that filters air from intake passage 114. In one embodiment, the turbocharger system 160 may include a turbocharger sensor 170, which may be configured to measure an output of the turbocharger system 160, such as speed of one or more turbocharger system 160 components. In an alternate embodiment, the turbocharger sensor 170 may be adjacent to the turbocharger system 160.

In some embodiments, the vehicle system 100 may further include an exhaust gas treatment system coupled in the exhaust passage upstream or downstream of the turbocharger system 160. In one exemplary embodiment, the exhaust gas treatment system may include a diesel oxidation catalyst (DOC) and a diesel particulate filter (DPF). In other embodiments, the exhaust gas treatment system may additionally or alternatively include one or more emission control devices. Such emission control devices may include a selective catalytic reduction (SCR) catalyst, three-way catalyst, NOₓ trap, and/or various other devices or systems.

The rail vehicle 106 further includes a controller 110 to control various components related to the vehicle system 100. In one example, the controller 110 includes a computer control system. In one embodiment, the computer control system includes a processor, such as processor 140. The controller 110 may include multiple engine control units (ECU) and the control system may be distributed among each of the ECUs. The controller 110 further includes computer readable storage media, such as memory 142, including code for enabling on-board monitoring and control of rail vehicle operation. The memory 142 may include volatile and non-volatile memory storage.

The controller 110, while overseeing control and management of the vehicle system 100, may be configured to receive signals from a variety of engine sensors 150, as further elaborated herein, in order to determine operating parameters and operating conditions, and correspondingly adjust various engine actuators 152 to control operation of the rail vehicle 106. For example, the controller 110 may receive signals from various engine sensors 150 including, but not limited to, engine speed, engine load, boost pressure, exhaust pressure, ambient pressure, exhaust temperature, etc. As another example, the controller 110 may receive a signal from turbocharger sensor 170 that indicates a speed of a component of the turbocharger system 160. Correspondingly, the controller 110 may control the vehicle system 100 by sending commands to various components such as traction motors, alternator, cylinder valves, throttle, etc. Signals from engine sensors 150 and from the turbocharger sensor 170 may be conveyed over one or more signal wires, e.g., which are bundled together into one or more wiring harnesses to reduce space in the vehicle system 100 devoted to wiring and to protect the signal wires from abrasion and vibration.

The controller 110 may be further linked to a display 120, such as a diagnostic interface display, providing a user interface to the locomotive operating crew and a maintenance crew. The controller 110 may control the engine 104, in response to operator input via user input controls 130, by sending a command to correspondingly adjust various engine actuators 152. Non-limiting examples of user input controls 130 may include a throttle control, a braking control, a power switch, and a fuel pump breaker (FPB) switch. For example, the operator may enable or disable a FPB of the locomotive by toggling a FPB switch of the user input controls 130.

The controller 110 may include onboard electronic diagnostics for recording system and component failures of vehicle system 100. In one embodiment, faults may be stored in memory 142. For example, the controller 110 may monitor the voltage of a signal from the turbocharger system 160. If the voltage of the signal is outside of a predetermined voltage range, the controller 110 may record a fault in memory 142. In one embodiment, a message may be transmitted to a command center by a radio transmitter (not shown) when the fault is detected and the vehicle system 100 may be scheduled for maintenance. In one embodiment, an operator crew may be notified of the fault by information posted on display 120. When the vehicle system 100 is being repaired, a list of system faults may be retrieved from memory 142 and displayed on the display 120. In one embodiment, the maintenance crew may direct the controller 110 to perform engine diagnostics. For example, the maintenance crew may enter a command via user input controls 130 for one or more vehicle systems, such as the turbocharger system 160, to perform a self-test and report a status via the display 120. A root cause of some faults may be diagnosed in this manner, by using the onboard electronic diagnostics. Diagnosing faults of the turbocharger system 160 with the onboard electronic diagnostics may be less time consuming and costly than removing the turbocharger system 160. Thus, a method for diagnosing the turbocharger system 160 may include electronic diagnosing all or substantially all parts that are electronically diagnosable prior to removal or replacement of any parts of the turbocharger system 160 from the vehicle system 100. However, other faults may require additional diagnosis, as further elaborated herein.

FIG. 2 illustrates an exemplary embodiment of the turbocharger system 160 connected to the controller 110 through one or more wiring harnesses, such as first, second, and third wiring harnesses 210, 212, and 214. In one embodiment, a signal from the turbocharger sensor 170 is routed to the controller 110 through the first wiring harness 210, to a first connection 230, to the second wiring harness 212, to a second connection 240, to the third wiring harness 214, and to the controller 110. In an alternate embodiment, the signal from the turbocharger sensor 170 is routed through a greater number of wiring harnesses connected in series between the turbocharger sensor 170 and the controller 110, as illustrated by break lines 250. Each wiring harness 210, 212, and 214 may carry signals from engine sensors 150. The first wiring harness 210 may include a first wiring harness connector 232. The second wiring harness 212 may include second and third wiring harness connectors 234 and 242. The third wiring harness 214 may include a fourth wiring harness connector 244. In one embodiment, the first connection 230 is formed by coupling the first connector 232 to the second connector 234. For example, the first connector 232 may include a set of pins that slide into a set of sockets of the second connector 234 to form the first electrical connection 230. In an alternate embodiment, the first connection 230 may be formed by coupling the first connector 232 to a system including a backplane and by coupling the second connector 234 to the system having the backplane. Thus, the first connection 230 may be formed by routing a signal from the first connector 232 across the backplane to the second connector 234. Similarly, the second connection 240 may be created by coupling third and fourth connectors 242 and 244 directly together or via a backplane or circuit board. During operation of vehicle system 100, one or more of the wiring harnesses 210, 212, and 214 and/or the connections 230 and 240 may become damaged and the damage may be recorded as a turbocharger system fault by the controller 110. For example, a corroded contact at the first or second connections 230 or 240 may cause a resistive path or an open connection between the turbocharger sensor 170 and the controller 110. Thus, the voltage associated with, the turbocharger sensor 170 and observed by the controller 110 may be outside of a predetermined range and a turbocharger sensor fault may be recorded in memory 142. Damage to one or more of the wiring harnesses 210, 212, and 214 and/or the connections 230 and 240 may be induced by vibration, abrasion, oxidation, electro-migration, and mishandling by operator or maintenance crew, as non-limiting examples.

Non-limiting examples of degraded connections 230 and 240 that may cause faults include: connections with housing damage, connections with missing lock tabs, connections with missing or damaged, seals, connections fouled with debris, and connections with damaged connectors. Connectors may be damaged if pins or sockets are damaged, for example. Non-limiting examples of damaged pins include: bent pins, burnt pins, pushed pins, corroded pins, pins with fretting, and pins with false brinelling. Non-limiting examples of damaged sockets include: oversized sockets, malformed sockets, burnt sockets, and corroded sockets.

Degraded connections may often be observed by a visual inspection. Inspection and repair of the degraded connections may be less time consuming and costly than removing the turbocharger system 160 from the engine system, vehicle, etc. Thus, a method for diagnosing the turbocharger system 160 may include visually inspecting all or substantially all parts that are visually inspectable prior to removal or replacement of any parts of the turbocharger system 160 from the vehicle system 100. However, not all faults of turbocharger system 160 may be diagnosed with an electronic diagnosis or a visual inspection.

Additional diagnosis may include physically manipulating a component of the turbocharger system 160 while observing an output from the turbocharger system 160. FIG. 2 illustrates the turbocharger system 160 in an operational state. The turbocharger system 160 may include a turbocharger housing 260, a compressor wheel 262, and an air filter 266. The air filter 266 filters ambient air entering the turbocharger housing 260. The air filter 266 may be fouled by contaminants in the ambient air and so it is replaced at regular maintenance intervals. Thus, the turbocharger housing 260 may be configured for the air filter 266 to be quickly removed from the turbocharger housing 260 to reduce service time of the vehicle system 100 during regular maintenance intervals. The compressor wheel 262 rotates within the turbocharger housing 260. The rotation of the compressor wheel 262 may be measured via the turbocharger sensor 170. In one embodiment, the turbocharger sensor 170 is an active current loop output device and the controller 110 includes a voltage source and load resistor connected to the turbocharger sensor 170 through the wiring harnesses 210, 212, and 214. In one embodiment, the turbocharger sensor 170 toggles between 9.75 VDC (+/−0.5 VDC) and 11.5 VDC (+/−0.5 VDC) when powered by the voltage source of the controller 110 and as the compressor wheel 262 is rotated. In this manner, the controller 110 may measure the rotational velocity of the compressor wheel 262 by calculating the frequency of the signal from the turbocharger sensor 170. The controller 110 may also monitor the voltage of the signal from the turbocharger sensor 170 and if the voltage is outside of a predetermined range a turbocharger sensor fault may be recorded in memory 142. For example, the controller 110 may record a fault if the voltage from the turbocharger sensor 170 is less than 9.25 VDC or greater than 12.0 VDC. If such a fault is recorded, turbocharger sensor 170 may be further diagnosed as elaborated in FIG. 3.

FIG. 3 illustrates an exemplary embodiment of a diagnostic kit for diagnosing the turbocharger system 160. In one embodiment, the diagnostic kit includes a tester 330 and a human readable media 380. In another embodiment, the diagnostic kit includes the tester 330, the human readable media 380, and a physical manipulation tool 310. The human readable media 380 specify how to diagnose the fault source of the turbocharger system 160 using the tester 330 and the physical manipulation tool 310. In one embodiment, the human readable media 380 include a booklet, and the diagnostic kit includes the booklet. In one embodiment, and as further elaborated in FIG. 5, one or more instructions of the human readable media 380 are printed on a housing of tester 330. In one embodiment, the human readable media 380 are stored on computer readable media, such as a CD-ROM, and the diagnostic kit includes the CD-ROM. In another embodiment, the human readable media 380 include information on how to retrieve additional instructions via a web-site accessible over the Internet.

In one example, the human readable media 380 may include information on how to connect the tester 330 to the turbocharger system 160 as illustrated in FIG. 3. The tester 330 may be inserted in series between the turbocharger sensor 170 and the controller 110. For example, the first connection 230 in FIG. 2 may be disconnected by decoupling the first and second connectors 232 and 234, and the tester 330 may be inserted at this point of the circuit. The tester 330 may include one or more tester connectors 324, 342, and 350 for electrically connecting the tester to the vehicle system 100. In one embodiment, first and second tester connectors 324 and 342 are complementary. For example, the first tester connector 324 may include a set of sockets configured in a pattern and the second tester connector 342 may include a set of pins configured in the pattern. In one embodiment, the first tester connector 324 includes a set of sockets configured to slide into a set of pins of the first wiring harness connector 232. Thus, an electrical connection 320 can be made by coupling the first tester connector 324 to the first wiring harness connector 232. Similarly, an electrical connection 340 can be made by coupling the second tester connector 342 to the first connector 234. In another embodiment, the third tester connector 350 is operable for connecting the tester 330 to a chassis ground 360 of vehicle system 100 or other another electrical ground. The connector 350 may be an alligator clip, a ground clamp, or the like.

One or more components of the controller 110 may be sensitive to electrostatic discharge and so it may be desirable to use precautions when connecting or disconnecting the tester 330 to the vehicle system 100. For example, power may be switched off to the controller 110 prior to connecting or disconnecting the tester 330. In one embodiment, power may be switched off by toggling a fuel pump breaker switch of the user input controls 130. In one embodiment, the controller 110 includes a power indicator light 370 that is lit when power is applied. Thus, the maintenance crew may confirm that power is switched off to the controller 110 by observing that the power indicator light 370 is not lit. It may be desirable for a technician of the maintenance crew to wear anti-static gloves prior to connecting or disconnecting the tester 330. It may also be desirable for the technician to discharge potential static charge by touching the chassis ground 360 prior to touching an open connector of the vehicle system 100. Similarly, it may be desirable for the technician to wear an anti-static strap connected to the chassis ground 360 prior to touching an open connector of the vehicle system 100.

The human readable media 380 may include information on how to use the tester 330 to observe an output of the turbocharger system 160. For example, the tester 330 may be used to observe a voltage that varies as the compressor wheel 262 is rotated. The physical manipulation tool 310 may be configured to manipulate at least a portion of the turbocharger system 160. In one embodiment, the physical manipulation tool 310 is configured to rotate the compressor wheel 262. The physical manipulation tool 310 may include a coupling end 312, a flexible portion 316, and a handle 318. The coupling end 312 may be configured to couple to the compressor wheel 262. In one embodiment, the compressor wheel 262 includes a coupling component 264. For example, the coupling component 264 may be a nut, and the coupling end 312 may include a hollow 314, such as a socket configured to slide over the nut and couple the coupling component 264 to the coupling end 312. Alternatively, coupling component 264 may be a protrusion and the hollow 314 may be configured to slide over the protrusion and couple the coupling component 264 to the coupling end 312. In another embodiment, the coupling end 312 includes a material having a high coefficient of static friction when placed against the compressor wheel 262, and the coupling end 312 couples to the compressor wheel 262 through friction. In another embodiment, the physical manipulation tool 310 is an extension handle. General Electric Company (GE) part number 84D722116G1, with a 15/16 inch socket attached.

The human readable media 380 may include information on how to couple the physical manipulation tool 310 to the compressor wheel 262 and to rotate the compressor wheel 262. Access to the compressor wheel 262 may be blocked by the air filter 266. Thus, the air filter 266 may be removed from turbocharger housing 260 prior to coupling the physical manipulation tool 310 to the compressor wheel 262. As further elaborated in FIGS. 4, 6, and 7, an output of the turbocharger system 160 may be observed by rotating the compressor wheel 262 using the physical manipulation tool 310.

FIG. 4 illustrates a schematic diagram of an exemplary embodiment of the tester 330. The tester 330 may include a connector for connecting to test equipment 390, such as a digital multimeter (DMM) or an oscilloscope, for example. In one embodiment, the tester 330 includes plural test equipment connectors 460, 470, 472, 474, 476, and 478 for connecting to test equipment 390. In one embodiment, a first test equipment connector 460 of the tester 330 is a BNC connector and other test equipment connectors 470, 472, 474, 476, and 478 of the tester 330 are banana jacks for connecting to banana plugs. The tester 330 may include a mode switch 440, a first cable 410 connected to the first tester connector 324 and the mode switch 440, and a second cable 420 connected to the second tester connector 342 and the mode switch 440. The first cable 410 may include first and second signal wires 412 and 414 and a first shield wire 416. The second cable 420 may include second and third signal wires 422 and 424 and a second shield wire 426. The second signal wire 422 may be connected to test equipment connector 474 and a first lead of the first test equipment connector 460. The third signal wire 424 may be connected to test equipment connector 476 and a second lead of the first test equipment connector 460. The second shield wire 426 may be connected to test equipment connector 478.

The mode switch 440 may be configured so that one or more voltages of the vehicle system 100 may be observed when the tester 330 is connected as in FIG. 3. In one embodiment, the tester 330 has two modes and the mode switch 440 is a double throw, triple pole switch. In another embodiment, the tester 330 has three modes and the mode switch 440 is a triple throw, triple pole switch.

In one example, the tester 330 may include an unloaded mode for measuring a voltage from the controller 110 without the load of the sensor 170 and an insulation resistance of the first wiring harness 210. The insulation resistance of the first wiring harness 210 is measured by connecting the first wiring harness 210 to the first cable 410 through electrical connection 320 and switching the mode switch 440 to an unloaded mode position. In this manner, wires 412, 414, and 416 and connector 472 are electrically connected together and the insulation resistance can be measured across connectors 470 and 472 with a DMM 390. The unloaded voltage from the controller 110 may be measured by connecting wiring harness 212 to cable 420 through connection 340 and powering on the controller 110. The unloaded voltage may be measured across connectors 474 and 476 with a DMM 390. In one embodiment, the unloaded voltage is within specification when it is 12 VDC (+/−0.25 VDC).

In another example, the tester 330 may include a loaded mode for measuring the voltage from the controller 110 when it is loaded by the sensor 170. The loaded voltage from the controller 110 is measured by connecting the second wiring harness 212 to the second cable 420 through connection 340, switching the mode switch 440 to a loaded mode position, and powering on the controller 110. In this manner, the sensor 170 is connected to the controller 110 through the tester 330. The loaded voltage may be measured across connectors 474 and 476 with DMM 390. Furthermore, by physically manipulating at least a portion of turbocharger system 160, the loaded voltage and/or current may vary. In one embodiment, the loaded voltage is within specification when it toggles between 9.75 VDC (+/−0.5 VDC) and 11.5 VDC (+/−0.5 VDC) as the compressor wheel 262 is slowly rotated with the physical manipulation tool 310.

FIG. 5 shows an exemplary embodiment of the tester 330 that may include a housing 510 and a label. The label may be attached to or printed on the housing 510. A label may include an instruction of the human readable media 380. In one example, such as label 512, a label may identify a function of tester 330. Thus, the tester 330 may be readily identified by a member of the maintenance crew or other user. In another example, such as label 522, a label may identify the position of the mode switch 440 for a given mode setting. In another example, such as labels 530, 540, 542, and 550, labels may identify test points for measuring a voltage or resistance. In another example, such as labels 532 and 544, a label may identify a voltage or resistance value expected at a test point for a given mode. By including an instruction on the housing 510 of the tester 330, a member of the maintenance crew (or other user) may potentially reduce errors or save time when diagnosing the turbocharger system 160.

Thus, the systems of FIGS. 1-5 provide for a vehicle system, comprising an engine including a turbocharger and a turbocharger sensor, the turbocharger sensor configured to measure an output of the turbocharger, a wiring harness connected to the turbocharger sensor, and a tester configured to couple to the wiring harness. The system further comprises a controller connected to the wiring harness, and includes the tester being coupled to the wiring harness, the tester configured to connect a signal between the controller and the turbocharger sensor in a first mode and to disconnect the signal between the controller and the turbocharger sensor in a second mode.

The systems of FIGS. 1-5 also provide for a system for diagnosing a fault source of a turbocharger system of an engine, the system comprising a tester including at least one connector operable to connect to a wiring harness of the turbocharger system, wherein the tester is configured to receive signals from the wiring harness for use in diagnosing the fault source, and human readable media with instructions that specify how to diagnose the fault source of the turbocharger system with the tester and without removing the turbocharger system. The system also includes a first connection path to transmit power from the controller to the sensor and a second connection path to enable measurement of power from the controller unloaded by the sensor. The system further comprises a physical manipulation tool for physical manipulation of the turbocharger system, wherein the instructions specify how to use the physical manipulation tool as part of diagnosing the turbocharger system, and wherein the physical manipulation tool is operable to couple to and decouple from a rotary component of the turbocharger system, the instructions further specifying to rotate the rotary component when the physical manipulation tool is coupled to the rotary component. The system includes the rotary component being a compressor wheel and the physical manipulation tool coupling to and decoupling from the compressor wheel. The system comprises the physical manipulation tool including a socket that couples to and decouples from the compressor wheel, a flexible portion connected to the socket, and a handle connected to the flexible portion. The system also includes wherein the tester includes a label and the label includes the human readable media, the human readable media comprising a booklet. The system includes the tester including a mode switch, wherein the mode switch includes a first position and a second position, and wherein the at least one connector of the tester comprises first and second connectors, the first position for receiving a first of the signals over the first connector from the wiring harness and the second position for receiving a second of the signals over the second connector from the wiring harness.

The systems of FIGS. 1-5 also provide for a system for diagnosing a turbocharger system fault, comprising a tester including at least one connector operable to connect to a wiring harness of the turbocharger system in order to receive signals from the wiring harness, a physical manipulation tool for physical manipulation of the turbocharger system, the physical manipulation tool including a socket that couples to and decouples from a compressor wheel of the turbocharger system, a flexible portion connected to the socket, and a handle connected to the flexible portion, and human readable media. The system includes the human readable media having instructions that specify connecting the tester to the wiring harness between a controller of the engine and a turbo speed sensor of the turbocharger system, coupling the socket to the compressor wheel, rotating the compressor wheel with the handle of the physical manipulation tool, observing a voltage range of a signal of the speed sensor via the tester, and if the observed voltage range is outside of +9.75 VDC (+/−0.5 VDC) or +11.5 VDC (+/−0.5 VDC), replacing the speed sensor.

FIG. 6 shows a flow chart of an exemplary embodiment of a method 600 for diagnosing the turbocharger system 160. In one example, the method 600 comprises exhausting all electronically diagnosable faults of turbocharger system 160 prior to removal of any parts of the turbocharger system 160. In another example, method 600 comprises electronically diagnosing a first set of parts to determine if any part of the first set of parts is a fault source. A second set of parts may be visually inspected to determine if any part of the second set of parts is the fault source. After electronically diagnosing the first set of paxts and visually inspecting the second set of parts and if no part of the first set of parts and the second set of parts are the fault source, a third set of parts may be diagnosed to determine if any part of the third set of parts is the fault source. The third set of parts may be diagnosed by physically manipulating a component of turbocharger system 160 while monitoring an output from turbocharger system 160. After diagnosing the third set of parts, and if no part of the third set of parts is the fault source, at least a portion of turbocharger system 160 may be removed from vehicle system 100.

For ease of illustration, a specific vehicle will be referred to as a non-limiting example of the inventive system and method. Particularly, a General Electric Company Evolution® Series Locomotive 106 with a GEVO V12 turbocharged diesel engine 104 will be used to illustrate embodiments of the invention. The turbocharger sensor 170 may be a “Turbo Right Speed sensor” (TRS) of the locomotive 106 with Common Control Architect. A TRS signal from the TRS sensor 170 is routed by a TRS cable 210 to a TRS connection 230. Engine Control A (EGA) harness 212 routes the TRS signal to an EGA connection 240 at an ECA junction box. The TRS signal and signals from engine sensors 150 are routed from the ECA junction box via wiring harness 214 to a connection in the Control Area “4,” second one “B” (C4B connection). The signals are routed from the C4B connection to an ECU connection of the controller 110. Thus, the TRS signal from the TRS sensor 170 is routed to the controller 110 through a series of harnesses and connections.

Returning to FIG. 6, at step 610, a set of parts may be visually inspected to determine if any part of the set of parts is the fault source. As part of a visual inspection, electrostatic discharge may potentially damage equipment of the locomotive 106 and precautions guarding against electrostatic discharge may be taken. For example, each time an open connector is to be touched or probed, a technician of the maintenance crew may discharge possible static by touching a metallic chassis ground 360 or using an anti-static strap connected to the chassis ground 360. As another example, electrical breakers may be turned off, such as the FPB which is an electrical circuit breaker that controls the power to the fuel pump and ECU. The FPB may switched off via the FPB switch of user input controls 130. A lock out procedure may be followed.

The turbocharger system 160 may be inspected to confirm that the engine 104 is fitted with the correct turbocharger, and a turbocharger speed sensor 170 that is appropriate for the engine 104 and the turbocharger. If the appropriate sensor 170 is not installed, the root cause of the failure may be found and the sensor 170 and the first wiring harness 210 may be replaced. Cables, including TRS cable 210, near first (e.g., TRS) connection 230 may be inspected. If the serial number of the cable is in the range of suspect cable or sensors with a known manufacturing issue, the sensor and/or cable may be the root cause of the fault and the sensor and/or cable may be replaced.

Electrical connections may be visually inspected to confirm that all electrical connections (e.g., TRS connection 230, ECA connection 240, C4B connection, and the ECU connection) are properly mated and in good condition. A cable in good condition may include: no housing damage; all lock tabs are present; seals are present and undamaged; pins and sockets are not bent, burnt, pushed, or corroded; there is no fretting present; there are no oversized contacts; and/or there are no malformed contacts or contacts fouled with debris or any other visible damage. Damaged connectors and contacts may be the root cause of the fault and it may be desirable to replace or repair them. Debris may be cleaned from contacts with a contact cleaner, such as commercially available GE part number 84A213494P1, and an aero-duster, such as GE part number 84A213494P3. It may not be desirable to use mechanical means (probes, wire brush, sand paper, and the like) to clean contacts, as abrasion may damage plated surfaces; however, use of mechanical means or not will depend on the means and type of contacts in question. Contact lubricant, such as commercially available GE part number 84A213494P2 (spray), may be applied to the pins or sockets, whereas commercially available contact lube GE part number 84A213494P4 (gel) may be applied to the sockets. If a connector is found to be corroded or has fretting, both sides of the connector may be replaced to renew the electrical contacts, since plugging a corroded connector into a new connector may transfer the corrosion.

At step 620, it is determined if a root cause of the fault of turbocharger system 160 has been discovered by a visual inspection. If a root cause is found, then diagnosis of turbocharger system 160 may be complete and method 600 may end. If a root cause of the fault of turbocharger system 160 is not found, method 600 may continue at 630.

At step 630, a set of parts may be electronically diagnosed to determine if any part of the set of parts is the fault source. In one example, the tester 330, such as GE part number 41A296328CPP4, may be used to electronically diagnose the fault source. Prior to connecting the tester 330 to the locomotive 106, the FPB may switched off via the FPB switch of the user input controls 130. The first (e.g., TRS) connection 230 may be disconnected by unplugging the TRS cable 210 from the ECA harness 212. The tester 330 may be connected between the TRS cable 210 and the EGA harness 212, as illustrated in FIG. 3. Specifically, the first wiring harness connector 232 may be coupled with the first tester connector 324 to form electrical connection 320 and the second wiring harness connector 234 may be coupled with the second tester connector 342 to form electrical connection 340. The third tester connector 350 may be connected to a clean chassis ground 360 on the engine frame. The mode switch 440 of the tester 330 may be set to a first position associated with the unloaded mode. Test equipment 390, such as a DMM, may be used to check resistance across the “Insulation Resistance” test points 470 and 472 of the tester 330. If the resistance reading is less than a predetermined threshold value, e.g., 100 kohms, the turbocharger sensor 170 may be the root cause of the fault and the turbocharger sensor 170 may be replaced. In one embodiment of the tester 330, the predetermined threshold value of the insulation resistance may be printed on a label attached to the tester housing 510. The type of test equipment used to measure the resistance across test points 470 and 472 may be selected, e.g., as a function of the measuring voltage of the test equipment, to avoid electrical damage to the turbocharger sensor 170.

The test equipment 390 may be set to measure DC voltage and the leads of the test equipment 390 may be connected to “TRS Circuit” test points 474 and 476. The FPB may switched on via the FPB switch of the user input controls 130 to energize the ECU of the controller 110. In one embodiment of the locomotive 106, a green power indicator light 370 will be lit on the ECU when the FPB switch is in the proper position. If the voltage measured by the test equipment 390 across test points 474 and 476 is outside of a predetermined range, e.g., 12 VDC (+/−0.25 VDC), the root cause may be between the second wiring harness connector 234 and the controller 110. The C4B connection, the ECU connection, and the ECU excitation voltage may be examined further to narrow down the source of the root cause. If the voltage measured by the test equipment 390 across test points 474 and 476 is within the predetermined range, the loaded TRS circuit may be tested.

The loaded TRS circuit may be tested by setting the mode switch 440 of the tester 330 to a second position associated with the loaded mode. In one embodiment of the locomotive 106, the TRS circuit is energized when the FPB is switched on and the green (or otherwise colored) power indicator light 370 on the ECU is lit. When the TRS circuit is energized, the TRS circuit voltage across test points 474 and 476 may be measured by the test equipment 390 and the voltage may be compared to a predetermined voltage range. In one embodiment, the predetermined voltage range is either +9.75 VDC (+/−0.5 VDC) or +11.5 VDC (+/−0.5 VDC). In other words, a properly functioning TRS circuit voltage may be one of a plurality of defined levels with a properly functioning TRS sensor 170. In one embodiment of the tester 330, a label, such as label 544, may identify the predetermined voltage range.

If the measured TRS circuit voltage is outside of a predetermined voltage range, a root cause may be further narrowed. Possible causes may include one or more of the following: a failed sensor 170; an open or shorted cable or connector; or a failed ECU of the controller 110. The root cause may be isolated to the TRS sensor 170, by connecting a new TRS sensor to connector 324 of tester 330 for determining if the correct voltage is present (e.g., ˜11.5 VDC if the new sensor tip is in air and ˜9.75 VDC when the new sensor tip is touching ferrous metal).

At step 640, it is determined if a root cause of the fault of the turbocharger system 160 has been discovered by electronic diagnosis. If a root cause is found, then diagnosis of the turbocharger system 160 may be complete and method 600 may end. If a root cause of the fault of the turbocharger system 160 is not found, method 600 may continue at step 650.

At step 650, a set of parts may be diagnosed by physically manipulating a component of the turbocharger system 160 while monitoring an output from the turbocharger system 160. In one example, and as further elaborated with FIG. 7, the tester 330 may be used to observe a voltage generated by rotating the compressor wheel 262 using the physical manipulation tool 310.

If the tester 330 is not already installed, the FPB may be switched off via the FPB switch of the user input controls 130. The tester 330 may be connected between the TRS cable 210 and the ECA harness 212 via connections 320 and 340 respectively, and grounded with connector 350 to chassis ground, as illustrated in FIG. 3. Test equipment 390 may be connected to measure the TRS circuit voltage across test points 474 and 476. The mode switch 440 of the tester 330 may be set to a second position associated with the loaded mode. In one embodiment of the locomotive 106, the TRS circuit is energized when the FPB is switched on and the green power indicator light 370 on the ECU is lit.

In one embodiment, access to the compressor wheel 262 of the turbocharger system 160 may be gained by either removing any intervening baggy filter, such as the air filter 266, or a turbo inlet boot. The physical manipulation tool 310 may be coupled to the compressor wheel 262, such as by sliding the socket 314 over the compressor nut 264. The TRS circuit voltage across test points 474 and 476 may be observed while slowly rotating the compressor wheel 262 in a clockwise direction. The TRS circuit voltage may be compared to a pair of predetermined voltage ranges. In one embodiment, the pair of predetermined voltage ranges is +9.75 VDC (+/−0.5 VDC) and +11.5 VDC (+/−0.5 VDC). If the TRS circuit voltage does not toggle between each of the predetermined voltage ranges then the TRS sensor 170 maybe the root cause of the failure and the TRS sensor 170 maybe replaced.

At step 660, if the TRS sensor 170 is found to be the root cause of the fault, then the method 600 may end. Otherwise, diagnosis of the turbocharger system 160 may continue at step 670.

At step 670, at least a portion of the turbocharger system 160 may be removed from the vehicle system 100. For example, the TRS sensor 170 may be removed by using a sensor removal tool such as GE part number 84C602579P1. Once the TRS sensor 170 is removed, the turbocharger system 160 may be may be further diagnosed with a visual inspection of the TRS sensor 170 and the turbocharger system 160. For example, if a tip of the TRS sensor 170 is damaged, such as from contact with a turbo thrust collar, that indicates that the turbocharger system 160 has failed and the turbocharger system 160 may be replaced. If the tip of the TRS sensor 170 is not damaged, then additional visual inspections may be possible with the TRS sensor 170 removed. For example, a bore scope inspection in the sensor hole previously occupied by the TRS sensor 170 may reveal damage to the turbocharger system 160. It may be desirable to protect any sensor tips from damage or from debris accumulation, such as the collection of metal chips.

In one embodiment of the method 600, if no root cause for the turbocharger hardware failure is identified, a new turbo speed sensor 170, e.g., GE part number 41A296328BZP6, may be installed and the voltage output of the TRS circuit may be measured while the turbocharger system 160 is manipulated with the manipulation tool 310, as described at 650. If the TRS circuit voltage is out of range, e.g., not toggling between ˜9.75 VDC to ˜11.5 VDC, the above root cause investigation at steps 650-670 may be repeated. If the TRS circuit voltage is within the predetermined range, test equipment 390 and the tester 330 may be removed. Any removed components, such as air filter 266, may be replaced. TRS incidents stored in memory 142 may be reset, an engine load test may be performed, and the locomotive 106 may be released if no repeat incidents are observed.

In one embodiment of the method 600, if a root cause is determined at any intermediate step of method 600, the method may jump to a final validation step. If a problem still exists, the last step successfully performed may be returned to and trouble shooting may continue. Also, during the method 600, it may be desirable to not start the engine until a root cause failure is determined to avoid a potential engine over-speed event. It may be desirable to avoid starting, running, or turning over an engine that is coupled to a turbocharger that may include one or more damaged components.

FIG. 7 shows a flow chart of an exemplary embodiment of a method 700 for diagnosing the turbocharger system 160. Specifically, FIG. 7 illustrates a method for diagnosing a fault of the turbocharger system 160 by physically manipulating at least a portion of the turbocharger system 160 and monitoring (e.g., concurrently monitoring) an output from the turbocharger system 160. In one embodiment, the turbocharger system 160 is manipulated by using the manipulation tool 310 that is coupled to an access point of the turbocharger system 160. However, the access point may be blocked by one or more components of the vehicle system 100. Thus, at step 710, the one or more components that block the access point may be removed. For example, the air filter 266 contained in the turbocharger housing 260 may block the manipulation tool 310 from reaching the compressor wheel 262. The compressor wheel 262 may be made accessible by removing the air filter 266 from the turbocharger housing 260.

At step 720, the tester 330 may be connected to the vehicle system 100 as illustrated in FIG. 3 to enable an output of the turbocharger system 160 to be observed. In one embodiment, the tester 330 is connected by first decoupling connectors 232 and 234 that form connection 230. Connector 232 may be connected to connector 324 of tester 330 to form connection 320. Connector 234 may be connected to connector 342 of tester 330 to form connection 340. Connector 350 of tester 330 may be connected to chassis ground 360.

At step 730, the manipulation tool 310 may be coupled to the access point of the turbocharger system 160. For example, the manipulation tool 310 may be coupled to the compressor wheel 262 by sliding the socket 314 over the compressor nut 264.

At step 740, the compressor wheel 262 may be rotated using the physical manipulation tool 310. In one embodiment, the compressor wheel 262 is slowly rotated in a clockwise direction. At step 750, an output of the tester 330 may be monitored. For example, an output of the turbocharger system 160 may be observed by rotating the compressor wheel 262 using the physical manipulation tool 310 and monitoring a voltage across test points 474 and 476 of the tester 330.

One or more steps of methods 600 and 700 may be included as an instruction of the human readable media 380. By following the human readable media 380, a member of the maintenance crew or other user may diagnose the turbocharger system 160.

As used herein, “wiring harness” means one or more wires or other conductors for conducting electrical signals. In one example, a wiring harness includes two or more wires or other conductors, which are bundled together and are routed to extend along at least part of the same pathway.

Thus, the methods of FIGS. 6 and 7 provide for diagnosis of a turbocharger apparatus of a vehicle, comprising exhausting all electronically diagnosable faults of the turbocharger apparatus prior to removal of any parts of the turbocharger apparatus. Electronically diagnosable faults of the turbocharger apparatus comprise turbocharger faults that may be detected by the controller, including a voltage signal from one or more sensors of the turbocharger apparatus being outside a predefined range, damage to a connection between the turbocharger apparatus and the controller, etc. Additionally, electronically diagnosable faults may comprise turbocharger faults that may be detected by a tester as part of a diagnosis kit, including a failed turbocharger apparatus sensor, an open or shorted cable or connector, or a failed ECU of the controller, etc. Removal of any parts of the turbocharger apparatus may include removal of any diagnostically-relevant parts of the turbocharger apparatus. That is, those parts which are necessary in order to diagnose a fault, such as the turbine, compressor, sensor, etc.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The embodiments described herein are examples of articles, systems, and methods having elements corresponding to the elements of the invention recited in die clauses. This written description may enable those of ordinary skill in the art to make and use embodiments having alternative elements that likewise correspond to the elements of the invention recited in the clauses. The scope of the invention thus includes articles, systems and methods that do not differ from the literal language of the clauses, and further includes other articles, systems and methods with insubstantial differences from the literal language of the clauses. While only certain features and embodiments have been illustrated and described herein, many modifications and changes may occur to one of ordinary skill in the relevant art. The appended clauses cover all such modifications and changes.

1. A kit for diagnosing a fault source of a turbocharger system of an engine, the kit comprising:
a tester including at least one connector operable to connect to a wiring harness of the turbocharger system, wherein the tester is configured to receive signals from the wiring harness for use in diagnosing the fault source; and
human readable media with instructions that specify how to diagnose the fault source of the turbocharger system with the tester and without removing the turbocharger system.

2. The kit of claim 1, wherein the instructions further specify connecting the tester to the wiring harness between a controller of the engine and a sensor configured to measure an output of the turbocharger system.

3. The kit of claim 2, wherein the tester includes a first connection path to transmit power from the controller to the sensor and a second connection path to enable measurement of power from the controller unloaded by the sensor.

4. The kit of claim 1, further comprising a physical manipulation tool for physical manipulation of the turbocharger system, wherein the instructions specify how to use the physical manipulation tool as part of diagnosing the turbocharger system.

5. The kit of claim 4, wherein the physical manipulation tool is operable to couple to and decouple from a rotary component of the turbocharger system, the instructions further specifying to rotate the rotary component when the physical manipulation tool is coupled to the rotary component.

6. The kit of claim 4, wherein the rotary component is a compressor wheel and the physical manipulation tool couples to and decouples from the compressor wheel.

7. The kit of claim 6, wherein the physical manipulation tool includes a socket that couples to and decouples from the compressor wheel.

8. The kit of claim 7, wherein the physical manipulation tool further comprises:
a flexible portion connected to the socket; and
a handle connected to the flexible portion.

9. The kit of claim 1, wherein the tester includes a label and the label includes the human readable media.

10. The kit of claim 1, wherein the human readable media comprise a booklet.

11. The kit of claim 1, wherein the tester includes a mode switch.

12. The kit of claim 11, wherein the mode switch includes a first position and a second position, and wherein the at least one connector of the tester comprises first and second connectors, the first position for receiving a first of the signals over the first connector from the wiring harness and the second position for receiving a second of the signals over the second connector from the wiring harness.

13. A method for diagnosing a fault source of a turbocharger system of a vehicle, comprising:
electronically diagnosing a first set of parts of the turbocharger system to determine if any part of the first set of parts is the fault source;
visually inspecting a second set of parts of the turbocharger system to determine if any part of the second set of parts is the fault source; and
after electronically diagnosing the first set of parts and visually inspecting the second set of parts and if no part of the first set of parts and the second set of parts is the fault source, diagnosing a third set of parts to determine if any part of the third set of parts is the fault source, the third set of parts diagnosed by physically manipulating a component of the turbocharger system while monitoring an output from the turbocharger system.

14. The method of claim 14, further comprising, after diagnosing the third set of parts and if no part of the third set of parts is the fault source, removing at least a portion of the turbocharger system from the vehicle.

15. The method of claim 15, wherein the portion of the turbocharger system removed from the vehicle is a sensor of the turbocharger system.

16. The method of claim 16, further comprising, after removing the sensor, visually inspecting the sensor to further diagnose the fault source.

17. The method of claim 17, further comprising, after visually inspecting the sensor and if the sensor includes a damaged tip, removing the turbocharger system from the vehicle.

18. The method of claim 13, wherein visually inspecting the second set of parts includes verifying that a specified part is installed in the turbocharger system.

19. The method of claim 13, wherein visually inspecting the second set of parts includes checking for damaged electrical connections of the turbocharger system.

20. The method of claim 13, wherein physically manipulating a component of the turbocharger system includes rotating a compressor of the turbocharger system with a physical manipulation tool.

21. The method of claim 13, wherein monitoring an output from the turbocharger system includes observing a voltage range of a signal of the turbocharger system.

22. A method for diagnosing a fault source of a turbocharger system of a vehicle, comprising:
removing an air filter from a turbocharger housing of the turbocharger system;
inserting a physical manipulation tool into the turbocharger housing;
coupling the physical manipulation tool to a compressor within the turbocharger housing;
observing an output of the turbocharger system while rotating the compressor via the physical manipulation tool; and
removing a component of the turbocharger system from the vehicle based on the output of the turbocharger system.

23. The method of claim 22, wherein the component of the turbocharger system is a sensor.

24. The method of claim 22, wherein the compressor includes a coupling nut, the physical manipulation tool includes a socket, and the physical manipulation tool is coupled to the compressor by sliding the socket over the coupling nut.

25. A system for diagnosing a turbocharger system fault, comprising:
a tester including at least one connector operable to connect to a wiring harness of the turbocharger system in order to receive signals from the wiring harness;
a physical manipulation tool for physical manipulation of die turbocharger system, the physical manipulation tool including a socket that couples to and decouples from a compressor wheel of the turbocharger system, a flexible portion connected to the socket, and a handle connected to the flexible portion; and
human readable media with instructions that specify:
connecting the tester to the wiring harness between a controller of the engine and a turbo speed sensor of the turbocharger system;
coupling the socket to the compressor wheel;
rotating the compressor wheel with the handle of the physical manipulation tool;
observing a voltage range of a signal of the speed sensor via the tester; and
if the observed voltage range is outside of a predetermined voltage range, replacing the speed sensor.
